(19) United States
(12) Patent Application Publication
(10) Pub. No.: US 2009/0122526 A1
(43) Pub. Date: May 14, 2009

(54) Light emitting garment

(76) Inventor: Chia-Ho Lei, Taoyuan City (TW)

Correspondence Address: Chia-Ho Lei, P.O. Box 6-9 (717), Tainan, CN

(21) Appl. No.: 11/983,588

(22) Filed: Nov. 13, 2007

(51) Int. Cl. F21V 21/108

(52) U.S. Cl. 362/108

(57) ABSTRACT

This invention is a kind of light emitting garment in which the garment itself has numerous colored Light Emitting Diodes (LED) sandwiched inside two layers. The bottom edge of the garment has a pocket for a power supply device. The power supply device and LED are connected by wires. The Light Emitting Diodes are turned on or off using a switch on the power supply device. On the upper part of the garment there is a hoop worn around the wearer's neck and, on the bottom, there are bands that are tied around the wearer's body. The garment is worn inside formal attire and, after the garment's power is turned on, its Light Emitting Diodes emit different colored light. After dispersal by passing through the polyester filling that is in front of the Light Emitting Diodes, the light shines through the formal attire, surrounding the wearer with brightly colored light, allowing its beauty to be enjoyed by the wearer and other participants in the social occasion.

### BACKGROUND OF THE INVENTION

1. Field of the Invention

This invention is a kind of light emitting garment that use s an electric device to create a multi-colored light effect.

2. Description of the Prior Art

Social occasions are frequent in modern life. To show respect for other participants for various social occasions, formal attire is usually worn. However, the formal attire available today only has a basic function and does not meet the requirement for novelty in this era, leading to calls for innovation.

### SUMMARY OF THE INVENTION

The objective of the invention is to provide a garment that emits multi-colored light and is convenient and comfortable to wear.

### BRIEF DESCRIPTION OF DRAWINGS

This invention is better understood by referring to the accompanying drawings, wherein:

FIG. 1 is a structural schematic diagram of the invention; and

FIG. 2 is a structural schematic diagram of another embodiment of the invention.

### DETAILED DESCRIPTION OF THE PREFERRED EMBODIMENT

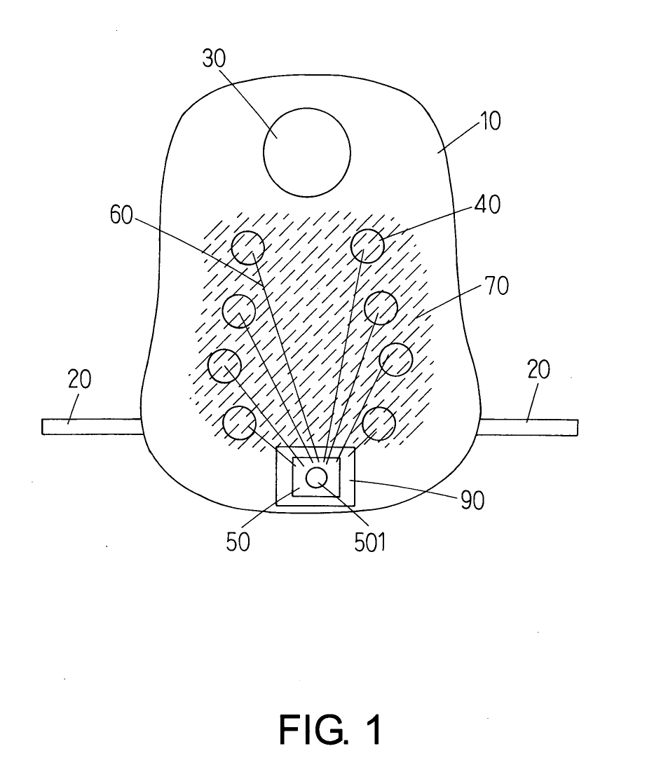

As shown in FIGS. 1˜2, a preferred embodiment of the light emitting garment in the present invention includes a garment 10, a different color LED 40, a power supply device 50, as main components.

As shown in FIG. 1, the main body of the garment 10 has two layers at the front. At the top of the garment is a hoop 30 that is worn around the wearer's neck. Between this hoop and the bottom of the garment 10, numerous different color LED 40 are sandwiched between the two layers. In front of the LED 40 inside the garment 10 is a polyester layer 70. The garment 10 has a pocket 90, to hold a power supply. The pocket 90 holds a power supply device 50. The pocket 90 keeps the power supply device 50 and LED 40 wires 60 in place and prevents them being exposed. This makes wearing the invention safe. In the battery case of the power supply device there is a space for a battery and a control circuit. In the space for the battery and control circuit there is a wire outlet, battery, control circuit and a control switch 501 connected to the LED 40.

When using the garment, first place the hoop 30 on the garment 10 around the neck, then knot the bands 20 on the garment 10 together, attaching the light emitting garment firmly to the body. After putting on the formal attire, by pressing the power switch 501, the LED 40 will be illuminated and the different colored light will shine through the formal attire, after being dispersed through the polyester layer 70, making the formal attire more beautiful in appearance.

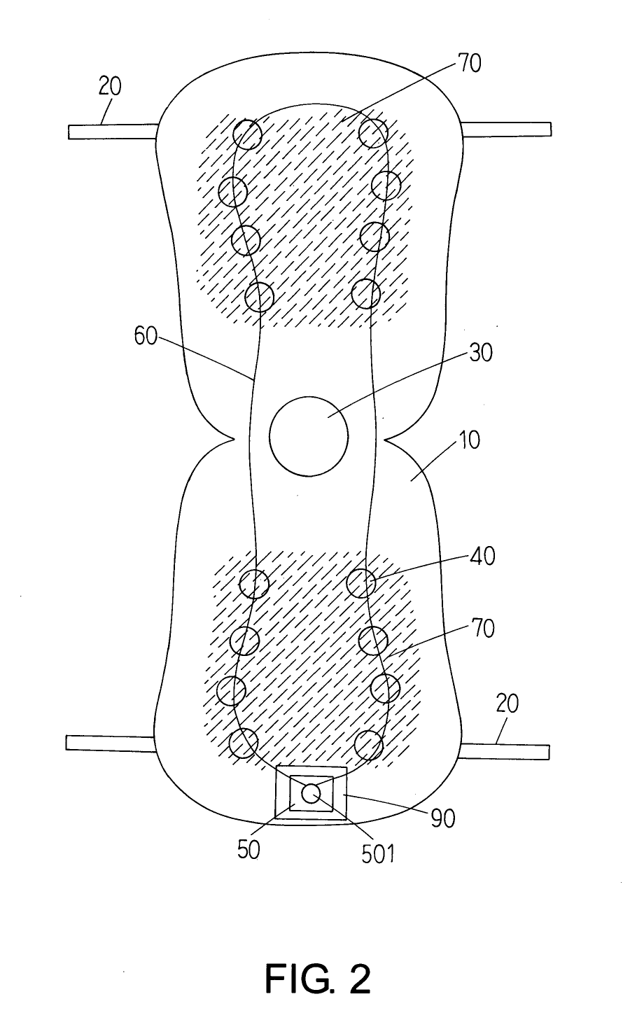

To meet the requirements of different users, if brighter or wider variety of colors are required then another embodiment of the invention can be used. As shown in FIG. 2, the garment has front and back parts. On the front and back of the garment 10, from hoop 30 to the bottom of the garment 10, are sandwiched numerous different colored LED 40. Inside the garment 10 there is a polyester filling in front of LED 40. There is a hoop 30 between the front and back of garment 10 which makes the front and back of the garment 10 cover the body of the wearer when the garment is worn. This design allows the LED 40 inside the garment 10 to cover the whole body when they shine, creating a better visual effect. For stability when wearing the garment there are bands 20 at the bottom of the garment 10 on each side. When these bands 20 are tied, the garment will remain firmly on the wearer's body.

While the preferred embodiment of the invention has been described above, it will be recognized and understood that various modifications may be made therein and the appended claims are intended to cover all such modifications that may fall within the spirit and scope of the invention.

What is claimed is:

1. A light emitting garment, including the garment itself and LED inside the garment. The special features are: the front of the garment is double layered and, in between the two layers, are sandwiched a number of LED. The garment itself has a power supply device pocket. Sandwiched in the garment layers is a connecting pocket containing the wires that connect the power supply device and the LED, preventing them from being exposed. The power supply device includes a battery case, control circuit and switch. In the battery case there is a space for the battery and the control circuit. There is wire outlet, battery and control circuit control switch and LED power source connection in the battery case control circuit space.

2. The light emitting garment as claimed in claim 1, wherein said the polyester filling in front of the LED that are sandwiched between the two layers at the front of the garment.

3. The light emitting garment as claimed in claim 1, wherein said the hoop on the upper part that is worn around the wearer's neck and bands at the bottom that are tied around the body.

4. The light emitting garment as claimed in claim 1, wherein said the LED made up of LED of two or more colors.

5. The light emitting garment as claimed in claim 1, wherein said the power supply pocket on the bottom at the front.

6. The light emitting garment as claimed in claim 1, wherein said the garment is a two layer back. In between the two layers are sandwiched a number of LED. These are connected to the power supply at the front of the garment.
